(19) United States
(12) Patent Application Publication
(10) Pub. No.: US 2019/0208085 A1
(43) Pub. Date: Jul. 4, 2019

(54) System and Methods of Managing Incoming Facsimile Messages in a Networked System

(71) Applicant: Lexmark International, Inc., Lexington, KY (US)

(72) Inventors: Thomas L. Coons, Richmond, KY (US); Craig A. Rudolph, Shelbyville, KY (US)

(21) Appl. No.: 15/856,560

(22) Filed: Dec. 28, 2017

(51) Int. Cl. H04N 1/44; H04N 1/00; H04N 1/32

(52) U.S. Cl. CPC H04N 1/4433; H04N 1/00209; G06F 17/21; H04N 1/00312; H04N 1/32379

(57) ABSTRACT

A system and methods of managing incoming fax messages at a multi-function imaging device connected to a network are disclosed. One example method includes receiving a fax message at the multi-function imaging device and identifying an intended recipient of the fax message. It is then determined if the intended recipient of the fax message is a registered user of the network. Upon a positive determination, the fax message is automatically added to an imaging queue associated with the intended recipient of the fax message.

### CROSS REFERENCES TO RELATED APPLICATIONS

None

### STATEMENT REGARDING FEDERALLY SPONSORED RESEARCH OR DEVELOPMENT

None.

### REFERENCE TO SEQUENTIAL LISTING, ETC.

None.

### BACKGROUND

### 1. Technical Field

The present invention relates generally to a system and methods of managing incoming facsimile messages. Specifically, the present invention refers to a system and methods for securely managing facsimile messages in a networked system.

### 2. Description of the Related Art

Generally, a multi-function peripheral device (“MFP”) may include various functions of existing office equipment, such as scanning, facsimile (“fax”), printing, and/or copying integrated into a single device and may be used independently, or in association with a computer. Typically, for MFPs that are connected to a fax line and are capable of receiving fax from a sender, incoming fax messages are automatically printed by the MFP when the MFP receives the fax messages. While current fax transmission systems provide a useful means of communicating documents and other information to respective recipients through MFPs, automatic printing of the fax messages may present some problems.

In corporations or enterprises with multiple users that utilize the MFP as the receiving fax machine, fax messages that are directed to the users may be received and automatically printed at the MFP. In some instances, the recipient user may not be notified of the receipt or printing of the fax document, and the printed document may remain on an output tray of the MFP for a period of time. For fax documents that contain sensitive or confidential information, this may pose as a security risk. For fax documents used as part of business process, such as where fax documents are utilized to place orders or collect revenue, this may add delay to the business process, which may result in negatively impacting the business or organization. Further, fax messages that do not have business value and do not need to be printed are automatically printed at the MFP, resulting in unnecessary and wasteful printing which can be an economic disadvantage to the corporation.

Thus, there is a need for a secure and optimized management of incoming fax messages in an MFP. There is also a need to efficiently manage incoming fax messages in MFPs utilized by one or more users in a network.

### SUMMARY

A system and methods for managing fax messages received at an imaging device connected to a network are disclosed. One example method for managing incoming fax messages may include receiving at the multi-function imaging device a fax message from a transmitting fax machine and determining an intended recipient of the fax message. The multi-function imaging device may identify if intended recipient is a registered user in the network. Each of the registered users is associated with an imaging or work queue for storing one or more imaging jobs. If the intended recipient is identified as a registered user of the network, the fax message may be added to the user's imaging or work queue.

From the foregoing disclosure and the following detailed description of various example embodiments, it will be apparent to those skilled in the art that the present disclosure provides a significant advance in the art of managing incoming fax messages. Additional features and advantages of various example embodiments will be better understood in view of the detailed description provided below.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is one example system for securely and efficiently managing incoming fax messages in a network.

FIG. 2 is an example method for managing incoming fax messages in the example networked system of FIG. 1.

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, may be implemented by special purpose hardware-based computer systems that perform the specified functions or steps or combinations of special purpose hardware and computer instructions.

Disclosed are an example system and example methods for managing incoming fax messages at a multi-function imaging device connected to a network. One example method for managing incoming fax messages may include receiving at the multi-function imaging device a fax message from a transmitting fax machine. An intended recipient of the fax message may be determined. The intended recipient may be checked against a list of one or more authorized or registered users in the network, and each of the registered users may have a data structure such as, for example, an imaging or work queue for storing one or more scan, imaging, copy and/or facsimile jobs. If the intended recipient is determined to be a registered user of the network, the fax message may be added to such user's imaging queue. Adding the fax message to the user's imaging queue allows the user to control disposition of the fax message. For example, by storing the incoming fax message in the user's imaging queue, the user is able to control whether to delete the fax message without printing, whether to print the fax message, when to process the fax message (e.g., when to print or e-mail the fax message, etc.) and/or whether to further process the fax message, such as by leveraging advanced Optical Character Recognition (OCR) technology to assess and associate where to further transmit the fax message, such as by e-mailing or sending to another storage medium, such as an electronic content management system for further processing. One such example of further processing is determining the incoming fax message is a purchase order and in addition to or instead of printing the fax message, the fax message contents may be sent to and further processed by an accounting system.

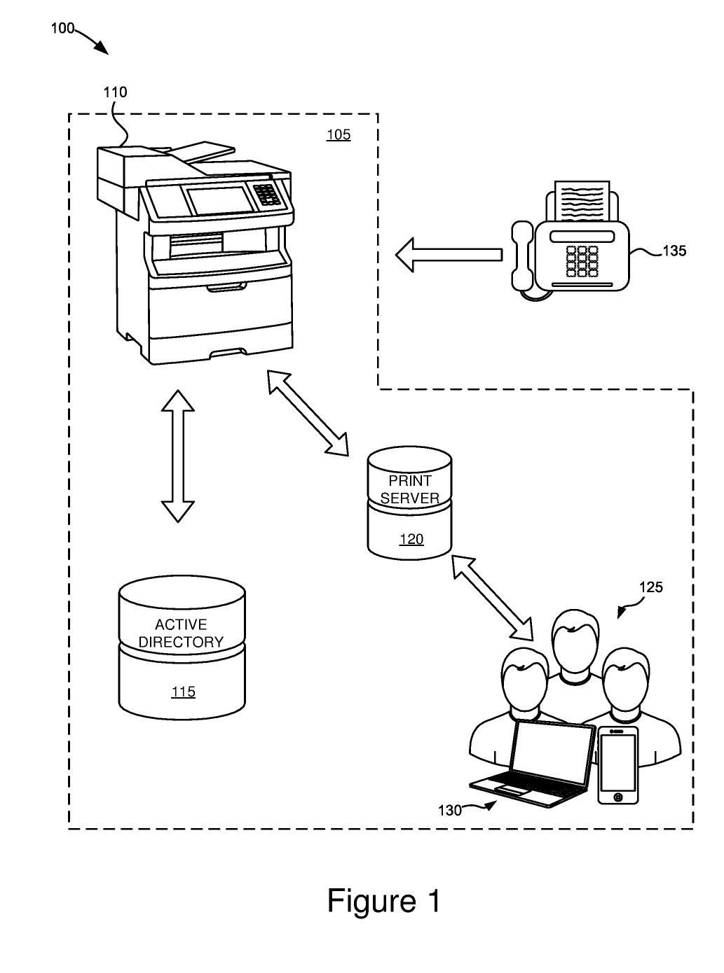

FIG. 1 is one example system for securely and efficiently managing incoming fax messages in a network. Example system 100 includes a network 105 having at least one imaging device 110, an active directory 115 communicatively connected to the imaging device 110, a print server 120, and one or more users 125. In one example embodiment, network 105 may be a print release computing environment where users 125 view, create, and/or modify documents using one or more client computing devices 130 such as smart phones, laptop computers, desktop computers, tablets, and the like, and users 125 may wish to obtain imaged media corresponding to such documents using at least one imaging device 110 from network 105.

Imaging device 110 may be, but is not limited to, a printer, copier, fax machine, all-in-one machine, or multi-function peripheral device (MFP), etc. Imaging device 110 may be a device configured to conduct facsimile communication such as the sending and/or receiving of images and written material from a transmitting fax machine 135 over a communication channel such as a telephone line, a network, a wireless link, and the like. Imaging device 110 may include a facsimile module (not shown) that includes executable instructions for decoding fax data received from the transmitting fax machine 135 and processing the fax data to generate imaging data to be printed. Imaging device 110 may communicate with print server 120 to retrieve one or more imaging jobs for imaging, as will be described in greater detail below.

Active directory 115 is a computing device, such as a server, but may typify other devices such as an LDAP server, a directory service, a storage volume, general purpose computer, a controller, database, etc. Active directory 115 defines a list of users 125, in an entity available or allowed to participate in the print release environment provided by network 105. Such users 125 may be clients, employees, contractors, partners, vendors, or anyone else permitted by the organization or enterprise to use network 105. Users 125 who are defined or registered with active directory 115 may be assigned an imaging queue that stores one or more imaging jobs initiated by the user. The imaging queue may be stored at print server 120 communicatively connected with imaging device 110. In some example embodiments, the imaging queue may correspond to a unique individual. In other example embodiments, the imaging queue may correspond to a particular group of individuals.

User 125 may initiate the imaging of items such as documents on client device 130. The items may be bundled together in an imaging job and include the requisite details of the item to be imaged along with metadata. The bundled items may then be packaged into an appropriate printer language for imaging device 110, such as Printer Command Language (PCL), Postscript, etc., as will be known in the art. Client device 130 may be used to initiate the imaging of items. For example, client device 130 may forward the imaging or a print job to print server 120, as in a known print release environment.

In one example embodiment, user 125 may be registered with active directory 115. Users registered with active directory 115 may be assigned with an imaging queue that stores or manages one or more imaging jobs that the user has forwarded to print server 120. When user 125 wishes to obtain a hard-copy of the imaging job at imaging device 110, user 125 may authenticate or log in at imaging device 110 to verify that the user is registered with active directory 115. If a user is registered with active directory 115, user 125 may be permitted to print or “release” an imaging job using imaging device 110. Upon successful authentication, imaging device 110 may communicate with print server 120 to access the corresponding imaging queue of the logged-in user and print or otherwise process the one or more imaging jobs stored in the imaging queue, as requested by the user.

In this example print release environment, print server 120 holds or stores the imaging jobs until users 125 initiate the printing of the imaging jobs at one of imaging devices 110 in network 105. In one example embodiment, print server 120 may store the imaging jobs for a predetermined amount of time such that, after the predetermined amount of time has elapsed, the imaging jobs may be deleted from the imaging queue of the user. Utilizing print server 120 in a print release environment securely manages imaging jobs such that the hard copies of sensitive documents are not printed until users authenticate themselves at imaging device 110 and request printing of the job. Print server 120 may also track printing habits and enforce compliance with established policies. For example, there may be a policy where no frivolous or unimportant documents are accidentally printed. In some example aspects, the company may desire that all incoming fax messages be only printed in black and white and/or leverage other advanced printing features to manage and control output spend and overall align with sustainability efforts. This technique holds users 125 accountable for the imaging of documents and prevents accidental release of hard copies to others.

Network 105 may be a local area network (LAN) or wide area network (WAN) that communicatively connects imaging device 100, active directory 115, print server 120, and client devices 130 together. Network 105 includes a variety of software to send and receive packets of information. Network 105 also includes hardware, such as routers, servers, switches, general or special purpose computers, transmission and relay towers, satellites, fiber optics, phone lines, cables, etc. The connections may be wired, wireless or a combination of wired and wireless communications between a few or many such hardware devices via an internet, intranet or other surrounding. Network 105 connects the devices in any configuration, not just the example configuration shown in FIG. 1.

Transmitting fax machine 135 may be any device capable of transmitting or sending fax messages, such as scanned printed material containing at least one of text and images. Transmitting fax machine 135 typically sends fax messages to a telephone number connected to a printer or other output device such as imaging device 110. Typically, fax machine 135 receives an original document from a computing device, a scanner, or telecopier; processes the message as a single fixed graphic image; converts the message into a bitmap; and transmits the message through a telephone system as a fax message to an intended recipient. A receiving fax machine or an MFP such as imaging device 105 may receive the message, interpret the signals sent through the telephone system, and reconstruct the image. The image may then be printed to a media, thereby resulting in a hard-copy of the fax document. In one example embodiment, transmitting fax machine 135 may send a fax message having metadata, which may include, for example, an intended recipient for the fax message, a telephone number to which the fax message will be sent, a title of the message, and other pertinent information.

In one example embodiment, transmitting fax machine 135 may send a fax message to network 105 to be printed by imaging device 110. The recipient of the fax message may be one of users 125 of network 105. In one example aspect, the telephone number to which the fax message is sent may be associated with imaging device 105 such that imaging device 105 receives the fax message and is expected to print the fax message upon receiving the fax message from transmitting fax machine 135. In another example aspect, network 105 may include a fax server (not shown) that allows users 125 whose client devices 130 are attached to the LAN to receive fax messages and print the fax messages using an associated imaging device such as imaging device 110.

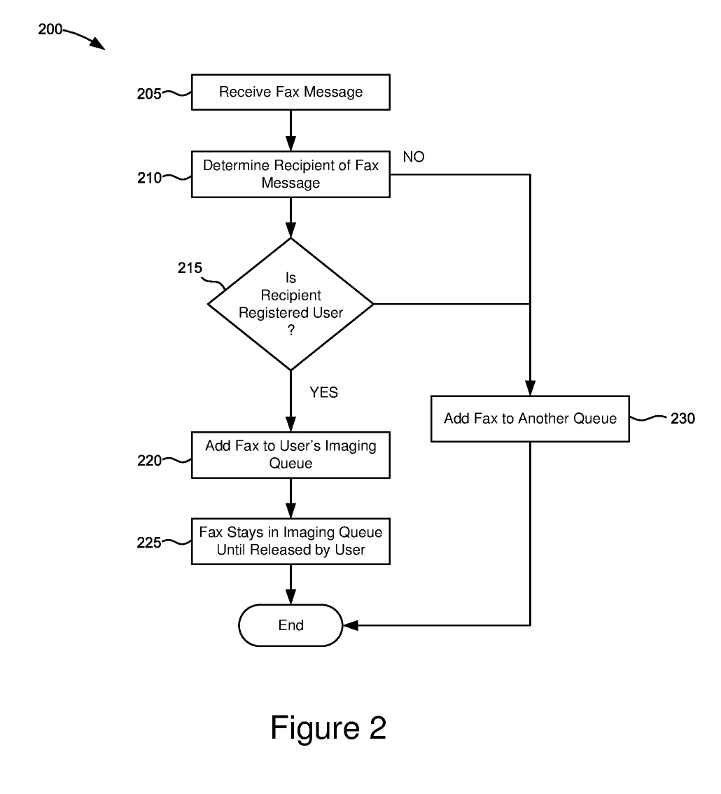

FIG. 2 is one example method for managing incoming fax messages in example networked system 100 of FIG. 1. For illustrative purposes, the example method 200 may be performed by imaging device 110 in networked system 100. Imaging device may have a processor for executing one or more instructions for managing fax messages received from transmitting fax machine 135. In another example aspect, example method 200 may be performed by a fax server that receives incoming fax messages from transmitting fax machine 135.

At block 205, an incoming fax message may be received. The fax message may be sent by transmitting fax machine 135 and received by imaging device 110 through a fax line, as is known in the art. In one example embodiment, the fax message may include metadata. For example, metadata information may include an intended recipient of the message, a title, and/or a recipient telephone number, among others. The intended recipient of the message may be a name of the recipient, an e-mail address of the recipient or another unique identifier associated with user 125.

At block 210, imaging device 110 may determine a recipient of the fax message from the metadata of the incoming fax message and identify if the determined recipient is a user registered to the active directory 115 (at block 215). Upon receiving the fax message, imaging device 110 may inspect the message to determine whether such the fax message contains metadata, and upon positive determination, imaging device 110 may read the metadata to determine if a recipient is indicated in the fax message.

At block 215, imaging device 110 may then determine if the recipient indicated in the fax message is a user registered to the active directory (at block 215). Determining if the recipient is a registered user in the active directory may include sending a query to active directory 115 to check whether a user in active directory 115 matches at least one of a name or an e-mail address indicated as a recipient in the metadata.

Upon determining that the recipient of the fax message is a registered user in active directory 115, the incoming fax message may be added to such user's imaging queue at block 220. Adding the fax message to the imaging queue of the recipient may be performed by sending the fax message to print server 120. Print server 120 may store the imaging queues of the users registered in the active directory, and enqueues the fax message as an imaging job in user 125 or recipient's imaging queue. In one example embodiment, user 125 may be notified (e.g., by e-mail) of the fax message addressed to user 125. In another example embodiment, user 125 may be notified when a fax message is added to the imaging queue of user 125.

Once added to the user's imaging queue, the fax message remains in the imaging queue until user 125 approaches imaging device 110 and controls imaging device 110 to print or “release” the fax message in order to obtain a hard-copy of the fax message. In one example embodiment, user 125 may be able to see a preview of the queued fax message so that the user may check or otherwise examine the contents of the fax message prior to deciding whether or not to print the fax message. As discussed above, when user 125 wishes to print the fax message, user 125 logs into imaging device 110 to access his or her imaging queue and selects the fax message from the imaging queue for printing by imaging device 110.

If at block 210, the imaging device 110 is unable to determine a recipient of the fax message such as, for example, when the intended recipient of the fax message is a telephone number or a corporation and not an individual, or if the fax message did not indicate a recipient, imaging device 110 may add the fax message to a predetermined imaging queue. Similarly, if at block 215 it is determined that the recipient of the fax message is not a user registered to active directory 115, the fax message may be added to the predetermined imaging queue.

The predetermined imaging queue may be, for example, a dedicated imaging queue for handling incoming fax messages received by one or more imaging devices 110 of network 105. The dedicated imaging queue for handling incoming fax messages with no identified recipients may be used to store fax messages prior to being released by an authorized user such as, for example, a network or device administrator. Incoming fax messages that may be identified as spam or advertisements may also queued to the dedicated imaging queue and reviewed by the network administrator prior to being printed or processed. The administrator may manage the imaging queue and may be notified of the new fax message received by network 105 and may authorize the release of the fax message for printing at imaging device 110. The network administrator may control the printing of the fax message as is typical in a print release environment.

It will be understood that the example applications described herein are illustrative and should not be considered limiting. It will be appreciated that the actions described and shown in the example flowcharts may be carried out or performed in any suitable order. It will also be appreciated that not all of the actions described in FIG. 2 need to be performed in accordance with the example embodiments of the disclosure and/or additional actions may be performed in accordance with other example embodiments of the disclosure.

Many modifications and other example embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of managing incoming fax messages at a multi-function imaging device connected to a network having one or more registered users, comprising:
receiving a fax message at the multi-function imaging device;
determining an intended recipient of the fax message;
identifying if the intended recipient of the fax message is a registered user of the network; and
if the intended recipient of the fax message is identified as a registered user of the network, adding the fax message to an imaging queue associated with the intended recipient.

2. The method of claim 1, wherein the adding the fax message to the imaging queue includes adding the fax message as an imaging job to the imaging queue associated with the intended recipient.

3. The method of claim 1, wherein the determining the intended recipient of the fax message includes identifying from a metadata of the fax message the intended recipient of the fax message.

4. The method of claim 1, further comprising accessing by the intended recipient at the multi-function imaging device the imaging queue having the one or more imaging jobs associated with the intended recipient.

5. The method of claim 4, further comprising selecting by the intended recipient the fax message from the imaging queue for printing at the multi-function imaging device.

6. The method of claim 1, wherein upon determining that the intended recipient is not one of the one or more registered users of the network, adding the fax message to a separate imaging queue.

7. The method of claim 1, wherein upon determining that the intended recipient is not one of the one or more registered users of the network, adding the fax message to a separate queue to be printed at the multi-function imaging device at another time.

8. A system for managing incoming fax messages, comprising:
an imaging device for receiving a fax message; and
a server communicatively connected to the imaging device, wherein each of the plurality of registered users is associated with a corresponding print queue and wherein upon the imaging device receiving the fax message, the imaging device determines a recipient of the fax message and queries the server to identify if the recipient of the fax message is a registered user of the network; and upon a positive identification, adding the fax messages to the print queue of the registered user identified as the recipient of the fax message.

9. The system of claim 8, further comprising a print server for storing the print queues of each of the plurality of registered users in the network.

10. The system of claim 9, wherein the fax message is added to the print queue of the registered user identified as the recipient of the fax messages by sending the one or more fax messages to the print server for storing at the print queue of the registered user.

11. The system of claim 8, wherein the fax message received by the imaging device includes metadata indicating the recipient of the one or more fax messages.

12. The system of claim 8, wherein if the imaging device of the recipient of the fax messages is not one of the plurality of registered users in the network, adding the one or more fax messages to a predetermined print queue.

13. The system of claim 8, wherein at least one of the the determining the recipient, the querying the server, and the adding the one or more fax messages to the print queue is performed by a computing device communicatively connected to the imaging device.

14. The system of claim 13, wherein upon the imaging device receiving the fax message, the fax message is sent to the computing device.

15. An imaging device having a non-transitory computer readable storage medium containing one or more instructions for managing incoming fax messages, the one or more instructions comprising an instruction to:
receive a fax message, the fax message having metadata from a transmitting fax machine;
inspect the metadata of the fax message to determine an intended recipient of the fax message;
identify if the intended recipient of the fax message is one of a plurality of users registered to a network; and
if the intended recipient of the fax message is identified as one of the plurality of users registered to the network, add the fax message to an imaging queue associated with the intended recipient.

16. The imaging device of claim 15, further comprising an instruction to add the fax message to another imaging queue if the fax message is determined to not include an intended recipient.

17. The imaging device of claim 15, further comprising an instruction add the fax message to another imaging queue if the intended recipient of the fax message is not one of the plurality of users registered to the network.

18. The imaging device of claim 17, wherein the one or more instructions to identify if the intended recipient of the fax message is one of the plurality of users registered to the network includes an instruction to contact an active directory communicatively connected to the imaging device to determine if the intended recipient of the fax message is one of the plurality of users registered to the active directory.

19. The imaging device of claim 15, wherein the instruction for add the fax message to the imaging queue associated with the intended recipient includes an instruction to send the fax message to a print server that stores the imaging queue associated with the intended recipient.

20. The imaging device of claim 15, further comprising an instruction to automatically image the fax message as soon as the intended recipient logs into the imaging device.
